(19) United States
(12) Patent Application Publication
(10) Pub. No.: US 2017/0064182 A1
(43) Pub. Date: Mar. 2, 2017

(54) METHOD AND DEVICE FOR ACQUIRING IMAGE FILE

(71) Applicant: Xiaomi Inc., Beijing (CN)

(72) Inventors: Yi Gao, Beijing (CN); Hongqiang Wang, Beijing (CN); Yunyuan Ge, Beijing (CN)

(73) Assignee: Xiaomi Inc.

(21) Appl. No.: 15/249,797

(22) Filed: Aug. 29, 2016

(30) Foreign Application Priority Data
Aug. 31, 2015 (CN) 201510549190.7

(51) Int. Cl. H04N 5/232; G06F 17/30; H04N 5/765

(52) U.S. Cl. CPC H04N 5/23206; H04N 5/765; G06F 17/30106; G06F 17/30274

(57) ABSTRACT

A method for acquiring an image file is provided. The method includes: transmitting, from a first device to a second device, an image capturing instruction requesting the second device to turn on a camera; receiving, by the first device, image information transmitted from the second device according to the image capturing instruction, the image information being captured by the second device using the camera; receiving, by the first device, an instruction input by a user; and generating, by the first device, the image file based on the instruction and the image information.

### CROSS-REFERENCE TO RELATED APPLICATION

This application is based upon and claims priority to Chinese Patent Application 201510549190.7, filed on Aug. 31, 2015, the entire contents of which are incorporated herein by reference.

### TECHNICAL FIELD

The present disclosure generally relates to the field of terminal device technology and, more particularly, to a method and a device for acquiring an image file.

### BACKGROUND

With rapid development of technology, smart devices, such as smart phones, smart watches and smart glasses become popular for use in daily life. The smart devices are often provided with a camera such that a user may take photos or videos using the smart devices. For example, the user may turn on the camera and capture image information by clicking a camera icon or a predetermined physical button on the smart devices. After that, the user may take photos by clicking a photo icon or a corresponding physical button. The user may also start recording videos by clicking a video icon or a corresponding physical button and stop the recording by clicking the video icon or the physical button another time.

### SUMMARY

According to a first aspect of the present disclosure, there is provided a method for acquiring an image file, comprising: transmitting, from a first device to a second device, an image capturing instruction requesting the second device to turn on a camera; receiving, by the first device, image information transmitted from the second device according to the image capturing instruction, the image information being captured by the second device using the camera; receiving, by the first device, an instruction input by a user; and generating, by the first device, the image file based on the instruction and the image information.

According to a second aspect of the present disclosure, there is provided a method for providing image information, comprising: receiving, by a second device, an image capturing instruction transmitted from a first device; turning on a camera according to the image capturing instruction; and transmitting the image information captured by the second device using the camera to the first device.

According to a third aspect of the present disclosure, there is provided a first device for acquiring an image file, comprising: a processor; and a memory for storing instructions executable by the processor. The processer is configured to perform: transmitting, from the first device to a second device, an image capturing instruction requesting the second device to turn on a camera; receiving, by the first device, image information transmitted from the second device according to the image capturing instruction, the image information being captured by the second device using the camera; receiving, by the first device, an instruction input by a user; and generating, by the first device, the image file based on the instruction and the image information.

According to a fourth aspect of the present disclosure, there is provided a second device for providing image information, comprising: a processor; and a memory for storing instructions executable by the processor. The processer is configured to perform: receiving, by the second device, an image capturing instruction transmitted from a first device; turning on a camera according to the image capturing instruction; and transmitting, to the first device, the image information captured by the second device using the camera.

It is to be understood that both the foregoing general description and the following detailed description are exemplary and explanatory only and are not restrictive of the present disclosure, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for acquiring an image file, according to an exemplary embodiment.

FIG. 2 is a flowchart of a method for providing image information, according to an exemplary embodiment.

FIG. 3 is a schematic diagram illustrating a system environment, according to an exemplary embodiment.

FIG. 4 is a flowchart of another method for acquiring an image file, according to an exemplary embodiment.

FIG. 5 is a schematic diagram illustrating a user interface, according to an exemplary embodiment.

FIG. 6 is a block diagram of a device for acquiring an image file, according to an exemplary embodiment.

FIG. 7 is a block diagram of a generating module, according to an exemplary embodiment.

FIG. 8 is a block diagram of another generating module, according to an exemplary embodiment.

FIG. 9a is a block diagram of another device for acquiring an image file, according to an exemplary embodiment.

FIG. 9b is a block diagram of a transmitting module, according to an exemplary embodiment.

FIG. 10 is a block diagram of another device for acquiring an image file, according to an exemplary embodiment.

FIG. 11 is a block diagram of a device for providing image information, according to an exemplary embodiment.

FIG. 12 is a block diagram of another device for providing image information, according to an exemplary embodiment.

FIG. 13 is a block diagram of another device for providing image information, according to an exemplary embodiment.

FIG. 14 is a block diagram of another device for providing image information, according to an exemplary embodiment.

FIG. 15 is a block diagram of a terminal device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

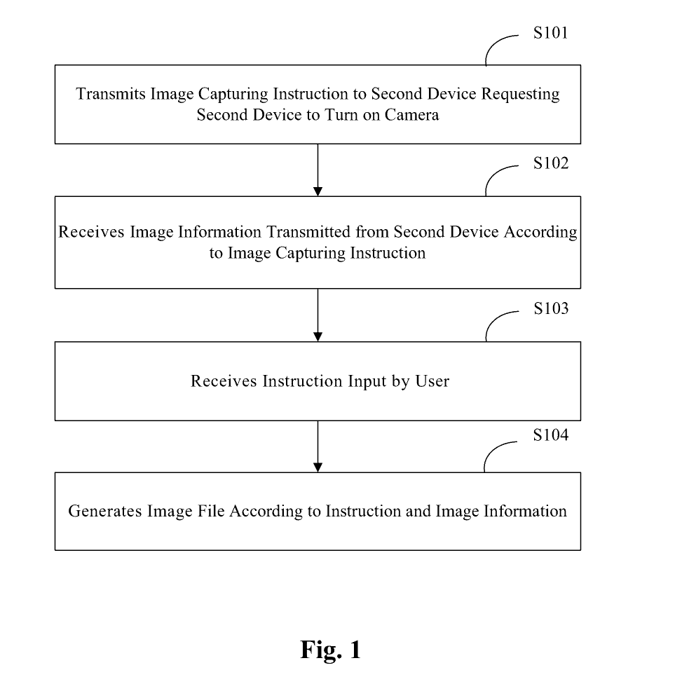

FIG. 1 is a flowchart of a method 100 for acquiring an image file, according to an exemplary embodiment. The method 100 is performed by a first device, which may be a terminal device, such as a smart phone, a tablet device, a PDA (Personal Digital Assistant), an e-book reader, a multimedia player, and the like. Referring to FIG. 1, the method 100 includes the following steps.

In step S101, the first device transmits an image capturing instruction to a second device.

The second device may include a built-in camera and may be a terminal device, such as a smart phone, a tablet device, a PDA, an e-book reader, a multimedia player or the like. The second device may turn on the camera upon receiving the image capturing instruction.

In step S102, the first device receives image information transmitted from the second device according to the image capturing instruction. The second device may capture the image information using the camera and transmit the image information to the first device in real time.

In step S103, the first device receives an instruction input by a user.

For example, the instruction may include a video recording instruction and or a photo taking instruction. The user may input the instruction by clicking a predetermined button or voice control, which is not limited in the present disclosure.

In step S104, the first device generates an image file according to the user instruction and the image information. where the image file includes a still image or a sequence of video images.

The image file may be stored locally in the first device. For example, when the user instruction is a photo taking instruction, at the time when the first device receives the photo taking instruction, the first device may obtain a latest image in the image information, generate the image file based on the obtained latest image, and store the image file locally. When the user instruction is a video recording instruction, the first device may set the time receiving the video recording instruction as a start time and set the time receiving a stop recording instruction as a stop time, continuously capture the image information from the start time till the stop time, generate the image file including a sequence of video images based on the image information, and store the generated image file locally.

In the method 100, the first device may generate the image file according to the instruction input by the user and the image information captured by the second device when it is inconvenient for the user to control the second device.

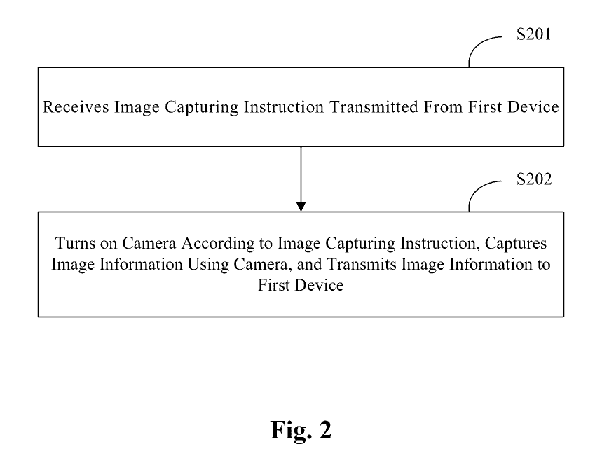

FIG. 2 is a flowchart of a method 200 for providing image information, according to an exemplary embodiment. The method 200 is performed by a second device. Referring to FIG. 2, the method 200 includes the following steps.

In step S201, the second device receives an image capturing instruction transmitted from a first device.

In step S202, the second device turns on a camera according to the image capturing instruction, captures image information using the camera, and transmits the image information to the first device in real time.

After receiving the image information, the first device may display the image information. If an instruction by the user is received, the first device may generate an image file according to the instruction and the image information and store the image file locally in the first device.

In some embodiments, the first device may establish a wireless connection with the second device, such as a Bluetooth connection, an IR (infrared) connection, a Wi-Fi connection and the like. The first device may transmit a control request to the second device via the wireless connection, and if the first device receives an indication sent from the second device indicating an acceptance of the control request, the first device may include an identification of the second device in a device table.

After receiving a table display instruction input by the user, the first device may display the device table to the user. For example, the first device may display the identifiers of all the devices in the device table to the user, and mark the current connection status of each of the devices in the device table. The first device may also display the identifiers of the devices having a connected status in the device table to the user. The first device may receive a selection of a second device in the device table by the user, and then transmit the image capturing instruction to the selected second device. After receiving the image capturing instruction, the second device may turn on the camera and capture image information.

After the second device transmits the captured image information to the first device, the first device may display the received image information in the display screen. If the first device is not provided with any display screen, the first device may display the image information in a plug-in display screen, or the first device may not display the image information.

In some embodiments, after receiving the instruction input by the user, the first device may transmit the instruction to the second device, and the second device generates the image file according to the instruction and the image information captured by the camera. For example, when the instruction is a photo taking instruction, the second device may obtain the latest image captured by the camera at the time when the photo taking instruction is received, generate the image file according to the latest image, and store the image file locally. When the instruction is a video recording instruction, the second device may set the time receiving the video recording instruction as a start time and set the time receiving a stop recording instruction as a stop time, continuously capture the image information from the start time till the stop time, generate an image file containing a sequence of video images according to the image information, and store the generated video locally. In doing so, the second device may be controlled to capture the image information when it is inconvenient for the user to control the second device.

In some embodiments, when the second device includes a display screen, the display status of the display screen of the second device may remain unchanged after receiving the image capturing instruction. For example, if the display screen of the second device is in a screen-off status before receiving the image capturing instruction, the display screen may be controlled to remain in the screen-off status after the second device receives the image capturing instruction. If the display screen of the second device is not in a screen-off status before receiving the image capturing instruction, the display screen may be controlled to remain in the same status after the second device receives the image capturing instruction. That is, instead of displaying the image information captured by the camera, the second device may maintain the display status as the same before receiving the image capturing instruction, so as to prevent other users from being aware of the image capturing action and protect the user's privacy.

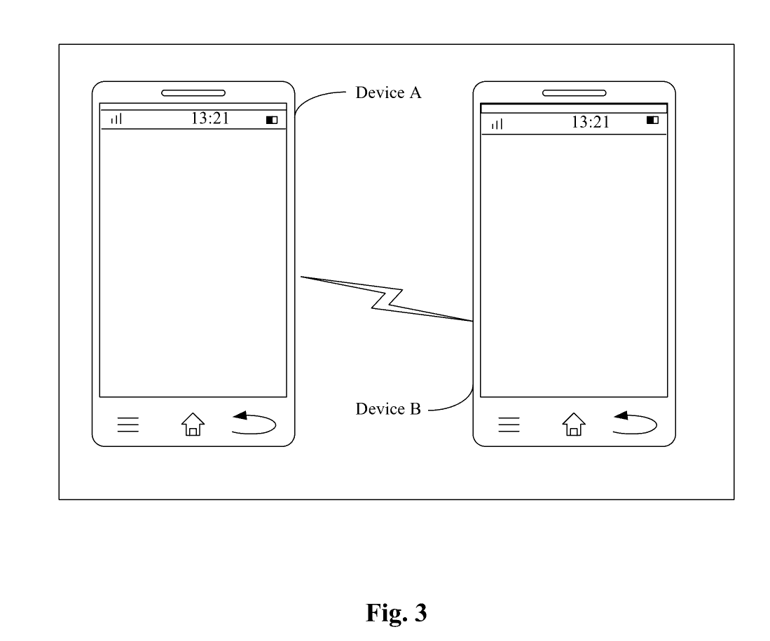

FIG. 3 is a schematic diagram illustrating a system environment 300, according to an exemplary embodiment. Referring to FIG. 3, the system environment 300 includes a first device A and a second device B, where the second device B includes a camera.

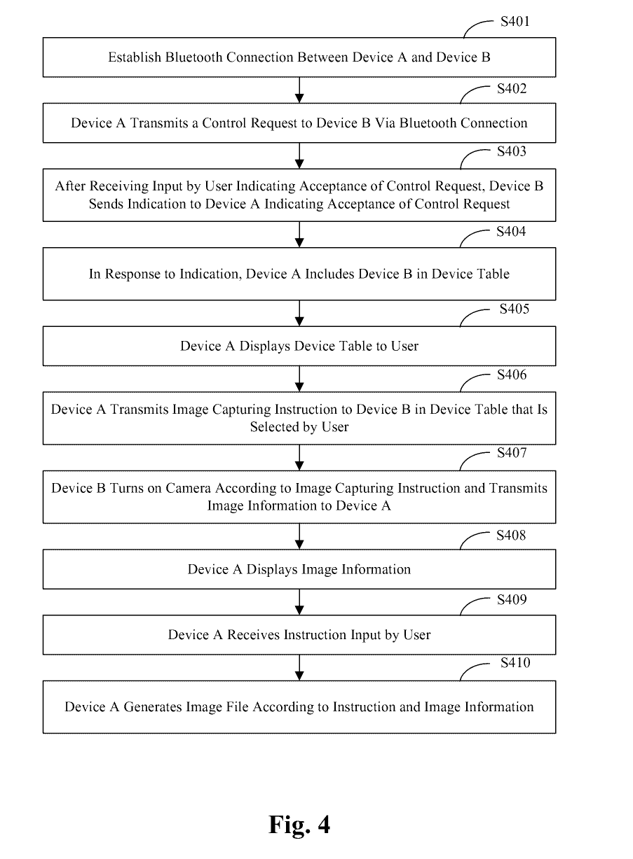

FIG. 4 is a flowchart of another method 400 for acquiring an image file, according to an exemplary embodiment. Referring to FIG. 4, the method 400 includes the following steps.

In step S401, a Bluetooth connection is established between device A and device B.

In step S402, device A transmits a control request to device B via the Bluetooth connection.

For example, when the user needs to control device B via device A, device A may transmit a control request to device B via the Bluetooth connection.

In step S403, after receiving an input by the user indicating an acceptance of the control request, device B sends an indication to device A indicating the acceptance of the control request.

In some embodiments, after receiving the control request, device B may prompt the user for confirmation to the control request. The user may input an accept instruction in device B indicating accepting the control request or input a reject instruction in device B indicating rejecting the control request.

After receiving the user input, device B may send the an indication to device A indicating an acceptance or a rejection of the control request.

In step S404, in response to the indication indicating the acceptance of the control request, device A includes device B in a device table.

For example, after receiving the indication indicating the acceptance of the control request sent from device B, device A may include an identifier of device B into the device table, such as a MAC address, a name and the like. The device table includes identifiers of the devices that are controllable by device A.

In step S405, device A displays the device table to the user.

In some embodiments, device A may display the device table to the user after receiving a table displaying instruction input by the user.

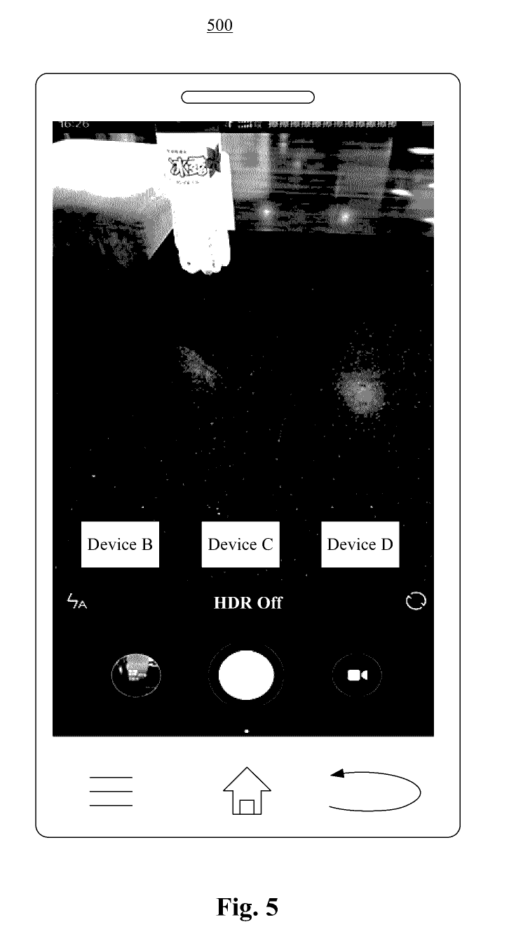

For example, the table displaying instruction may be a camera-on instruction. FIG. 5 is a schematic diagram illustrating a user interface 500, according to an exemplary embodiment. Referring to FIG. 5, after the user turns on the camera of the device, device A may determine that the table displaying instruction is received and display the device table to the user in a viewfinder frame. The “device B”, “device C” and “device D” illustrated in FIG. 5 are identifiers of devices that are controllable by device A, where “device B” is the identifier of the second device B. As another example, device A may display, in the device table, the identifiers of devices in the connected status, and may not display the identifiers of devices that are not connected with device A.

In some implementations, the user may input the table displaying instruction in an application (“APP”) loaded in device A, and device A may display the device table in response to the user input.

In step S406, device A transmits the image capturing instruction to device B in the device table that is selected by the user.

For example, when the user selects a certain device identifier, device A transmits the image capturing instruction to the corresponding device selected by the user.

For example, referring to FIG. 5, if the user clicks the “device B” in the user interface illustrated in FIG. 5, device A transmits the image capturing instruction to device B.

In step S407, device B turns on the camera according to the image capturing instruction and transmits captured image information to device A in real time.

In step S408, device A displays the image information received from device B.

In step S409, device A receives an instruction input by a user.

For example, after device A displays the image information, a user may input an instruction for device A to generate an image file based on the image information captured by device B. For example, the user may input a photo taking instruction and/or a video recording instruction via the user interface 500 illustrated in FIG. 5.

In step S410, device A generates an image file, such as a still image or a sequence of video images, according to the user instruction and the image information.

For example, device A may obtain an latest image in the image information at the time when receiving the instruction, generate an image file based on the obtained latest image, and store the image file locally. When a video recording instruction is received from the user, device A may set the time receiving the video recording instruction as a start time and the time receiving a stop recording instruction as a stop time, continuously capture the image information from the start time till the stop time, generate an image file including a sequence of video images based on the image information, and store the image file locally. For example, if the time when device A receives the video recording instruction is 15:00:00, and the time receiving the stop recording instruction is 15:10:00, device A sets the time 15:00:00 as the start time and the time 15:10:00 as the stop time, continuously captures the image information from 15:00:00 till 15:10:00, and generates the image file including a video according to the image information.

In some embodiments, when the user no longer needs to receive the image information captured by device B, the user may input a stop capturing instruction. For example, the user may click on the identifier “device B” illustrated in FIG. 5 another time. In response, device A may transmit a stop capturing instruction to device B, and device B may turn off the camera according to the stop capturing instruction to stop capturing the image information.

In some embodiments, if the user needs to receive image information captured by a third device with the identifier “device C”, the user may first click the identifier “device B” of the second device and then click the identifier “device C” of the third device. In response, device A may transmit a stop capturing instruction to device B and then transmit an image capturing instruction to device C, and device C may turn on the camera according to the image capturing instruction to capture the image information. In some embodiments, after receiving the selection in the device table input by the user, device A may determine whether the image capturing instruction has been transmitted to other devices, and if not, device A may transmit the image capturing instruction to the device selected by the user. If an image capturing instruction has been transmitted to other devices, device A may transmit a stop capturing instruction to the device to which the image capturing instruction has been transmitted, and transmit an image capturing instruction to the device selected by the user. For example, if the user needs to receive image information captured by the third device with the identifier “device C”, the user may click the identifier “device C” of the third device. Thereafter, device A may transmit a stop capturing instruction to device B and transmit an image capturing instruction to device C, thereby simplifying the user's operation.

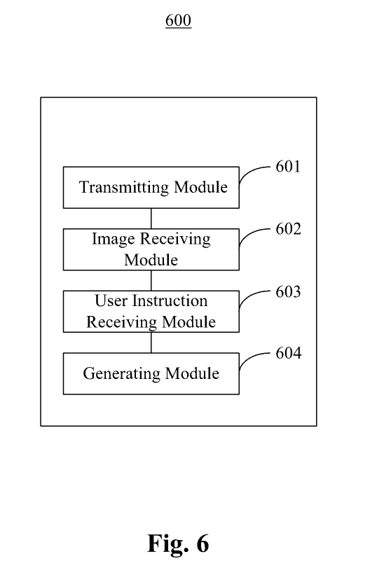

FIG. 6 is a block diagram of a device 600 for acquiring an image file, according to an exemplary embodiment. The device 600 may be implemented as a part or all of the first device described above. Referring to FIG. 6, the device 600 includes a transmitting module 601, an image receiving module 602, a user instruction receiving module 603, and a generating module 604.

The transmitting module 601 is configured to transmit an image capturing instruction to a second device, where the image capturing instruction requests the second device to turn on a camera.

The image receiving module 602 is configured to receive image information transmitted from the second device according to the image capturing instruction, where the image information is captured by the second device using the camera.

The user instruction receiving module 603 is configured to receive an instruction input by a user.

The generating module 604 is configured to generate an image file according to the received user instruction and the image information, where the image file may include a still image or a sequence of video images.

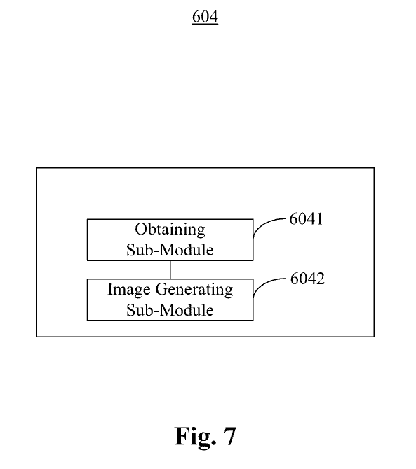

FIG. 7 is a block diagram of a generating module 604, according to an exemplary embodiment. Referring to FIG. 7, the generating module 604 includes an obtaining sub-module 6041 and an image generating sub-module 6042.

The obtaining sub-module 6041 is configured to obtain a latest image in the image information received by the image receiving module 602 at the time when the user instruction receiving module 603 receives a user instruction. For example, the user instruction received by the user instruction receiving module 603 may include a photo taking instruction for the device to generate an image file containing a still image.

The image generating sub-module 6042 is configured to generate an image file based on the latest image obtained by the obtaining sub-module 6041.

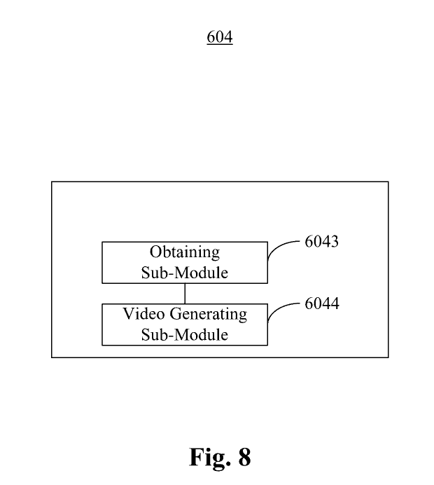

FIG. 8 is a block diagram of another generating module 604, according to an exemplary embodiment. Referring to FIG. 8, the generating module 604 includes an obtaining sub-module 6043 and a video generating sub-module 6044.

The obtaining sub-module 6043 is configured to set, according to a video recording instruction received by the user instruction receiving module 603, the time receiving the video recording instruction as a start time and the time receiving a stop recording instruction as a stop time, and continuously capture the image information from the start time till the stop time. For example, the user instruction received by the user instruction receiving module 603 may include a video recording instruction for the device to generate an image file, such as a video file including a sequence of video images.

The video generating submodule 6044 is configured to generate a video file based on the image information captured by the capturing sub-module 6043.

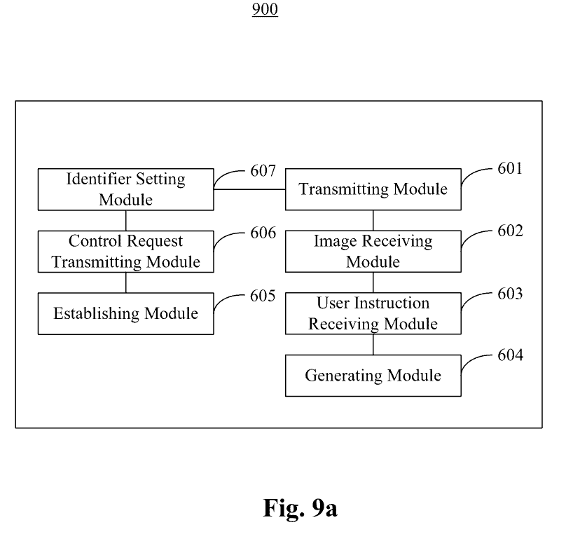

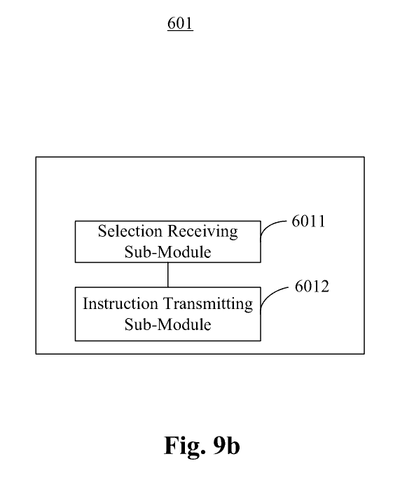

FIG. 9a is a block diagram of another device 900 for acquiring an image file, according to an exemplary embodiment. The device 900 may be implemented as a part or all of the first device described above. Referring to FIG. 9a, the device 900 further include an establishing module 605, a control request transmitting module 606, and an identifier setting module 607, in addition to the transmitting module 601, the image receiving module 602, the user instruction receiving module 603, and the generating module 604 (FIG. 6).

The establishing module 605 is configured to establish a wireless connection with the second device.

The control request transmitting module 606 is configured to transmit a control request to the second device via the wireless connection established by the establishing module 605.

The identifier setting module 607 is configured to include an identifier of the second device in a device table if an indication of acceptance is received from the second device in response to the control request transmitted by the control request transmitting module 606.

FIG. 9b is a block diagram of a transmitting module 601, according to an exemplary embodiment. Referring to FIG. 9b, the transmitting module 601 includes a selection receiving sub-module 6011 and an instruction transmitting sub-module 6012. The selection receiving sub-module 6011 is configured to receive a selection that is input by the user in the device table set by the identifier setting module 607.

The instruction transmitting sub-module 6012 is configured to transmit an image capturing instruction to the second device indicated by the selection received by the selection receiving sub-module 6011.

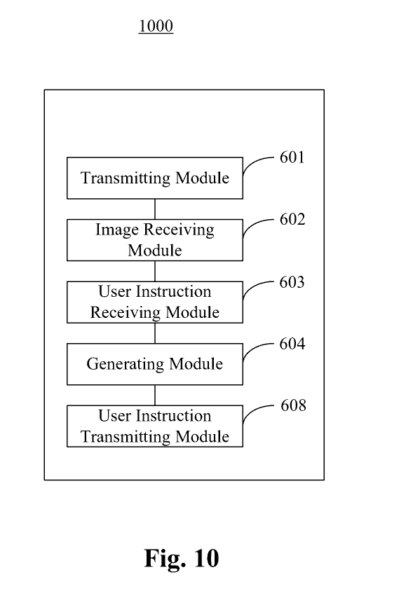

FIG. 10 is a block diagram of another device 1000 for acquiring an image file, according to another exemplary embodiment. The device 1000 may be implemented as a part or all of the first device described above. Referring to FIG. 10, the device 1000 further includes a user instruction transmitting module 608, in addition to the transmitting module 601, the image receiving module 602, the user instruction receiving module 603, and the generating module 604 (FIG. 6).

The user instruction transmitting module 608 is configured to transmit the instruction received by the user instruction receiving module 603 to the second device, where the second device is configured to, upon receiving the user instruction, generate an image file based on the image information captured by the camera. The image file may include a still image or a sequence of video images.

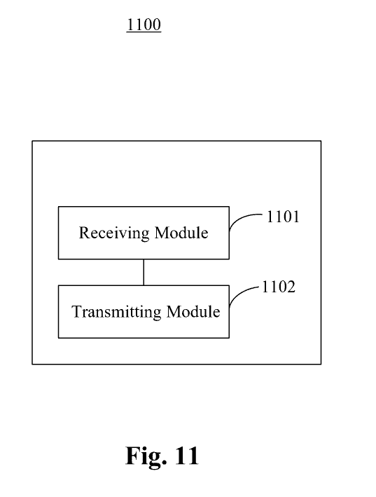

FIG. 11 is a block diagram of a device 1100 for providing image information, according to an exemplary embodiment. The device 1100 may be implemented as a part or all of the second device described above. Referring to FIG. 11, the device 1100 includes a receiving module 1101 and a transmitting module 1102.

The receiving module 1101 is configured to receive an image capturing instruction transmitted from a first device.

The transmitting module 1102 is configured to turn on a camera according to the image capturing instruction received by the receiving module 1101, and transmit, to the first device, image information captured by the second device using the camera in real time.

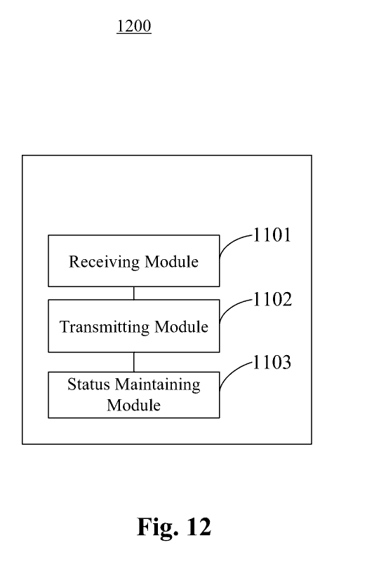

FIG. 12 is a block diagram of another device 1200 for providing image information, according to an exemplary embodiment. The device 1200 may be implemented as a part or all of the second device described above. Referring to FIG. 12, in addition to the receiving module 1101 and the transmitting module 1102 (FIG. 11), the device 1200 further includes a status maintaining module 1103.

The status maintaining module 1103 is configured to, when the capturing instruction receiving module 1101 receives the image capturing instruction, maintain a display screen of the second device in the same state as before receiving the image capturing instruction.

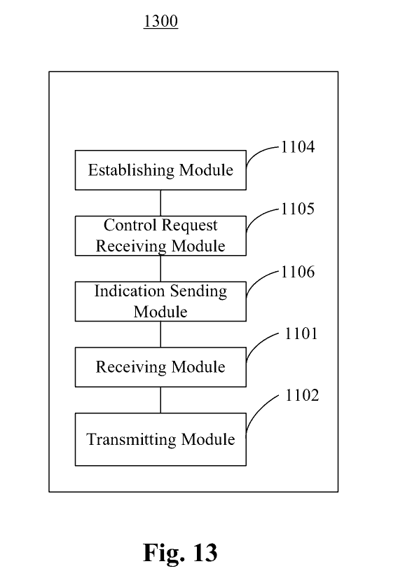

FIG. 13 is a block diagram of another device 1300 for providing image information, according to an exemplary embodiment. The device 1300 may be implemented as a part or all of the second device described above. Referring to FIG. 13, in addition to the receiving module 1101 and the transmitting module 1102 (FIG. 11), the device 1300 further includes a establishing module 1104, a control request receiving module 1105, and an indication sending module 1106.

The establishing module 1104 is configured to establish a wireless connection with the first device.

The control request receiving module 1105 is configured to receive a control request transmitted from the first device via the wireless connection established by the establishing module 1104.

The indication sending module 1106 is configured to, if an input by a user indicating an acceptance of the control request is received after the control request is received by the control request receiving module 1105, send an indication to the first device indicating the acceptance of the control request. The first device may include an identifier of the second device into a device table after receiving the indication.

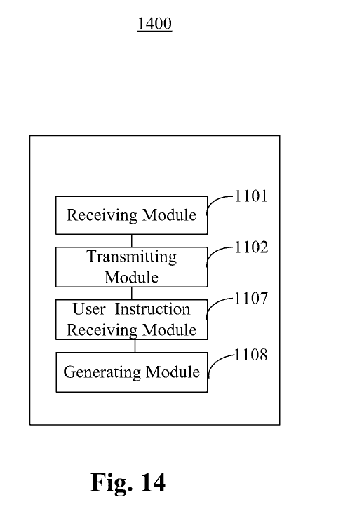

FIG. 14 is a block diagram of another device 1400 for providing image information, according to an exemplary embodiment. The device 1400 may be implemented as a part or all of the second device described above. Referring to FIG. 14, in addition to the receiving module 1101 and the transmitting module 1102 (FIG. 11), the device 1400 further includes a user instruction receiving module 1107 and a generating module 1108.

The instruction receiving module 1107 is configured to receive a user instruction transmitted from the first device.

The generating module 1108 is configured to generate an image file based on the user instruction received by the user instruction receiving module 1107 and the image information captured by the camera, where the image file may include a still image or a sequence of video images.

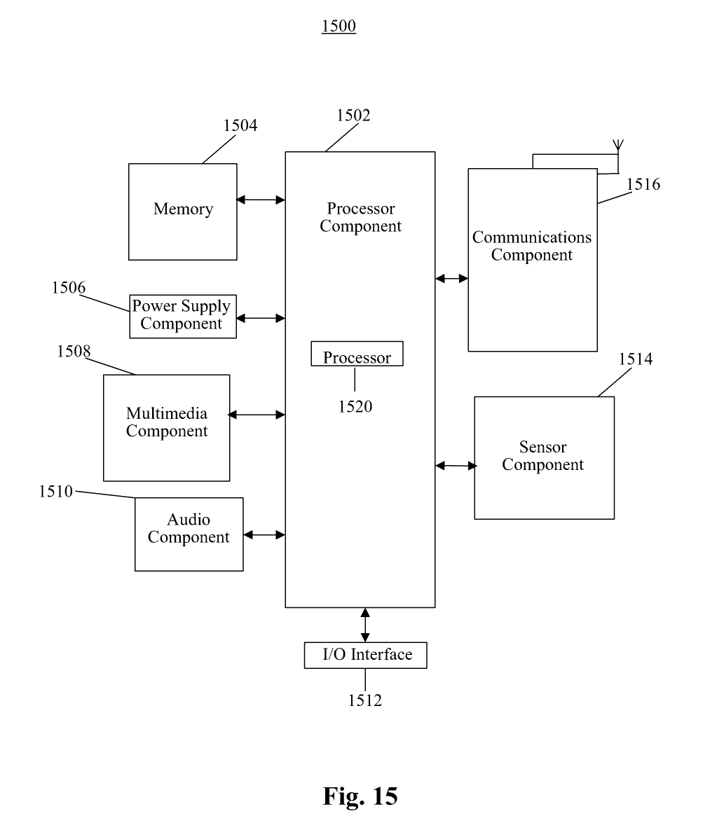

FIG. 15 is a block diagram of a terminal device 1500 according to an exemplary embodiment. The terminal device 1500 may be implemented as the first device or the second device described above. For example, the terminal device 1500 may be a mobile phone, a computer, a digital broadcast terminal, a messaging device, a gaming console, a tablet device, a medical device, exercise equipment, a personal digital assistant, and the like.

Referring to FIG. 15, the terminal device 1500 may include one or more of the following components: a processing component 1502, a memory 1504, a power component 1506, a multimedia component 1508, an audio component 1510, an input/output (I/O) interface 1512, a sensor component 1514, and a communication component 1516. The person skilled in the art should appreciate that the structure of the terminal device 1500 as shown in FIG. 15 does not intend to limit the terminal device 1500. The terminal device 1500 may include more or less components or combine some components or other different components.

The processing component 1502 typically controls overall operations of the terminal device 1500, such as the operations associated with display, telephone calls, data communications, camera operations, and recording operations. The processing component 1502 may include one or more processors 1520 to execute instructions to perform all or part of the steps in the above described methods. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the device 1500. Examples of such data include instructions for any applications or methods operated on the terminal device 1500, contact data, phonebook data, messages, images, video, etc. The memory 1504 is also configured to store programs and modules. The processing component 1502 performs various functions and data processing by operating programs and modules stored in the memory 1504. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power supply component 1506 is configured to provide power to various components of the terminal device 1500. The power supply component 1506 may include a power management system, one or more power sources, and any other components associated with the generation, management, and distribution of power in the terminal device 1500.

The multimedia component 1508 includes a screen providing an output interface between the terminal device 1500 and a user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the terminal device 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone configured to receive an external audio signal when the terminal device 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the terminal device 1500. For instance, the sensor component 1514 may detect an on/off state of the terminal device 1500, relative positioning of components, e.g., the display and the keypad, of the device 1500, a change in position of the terminal device 1500 or a component of the terminal device 1500, a presence or absence of user contact with the terminal device 1500, an orientation or an acceleration/deceleration of the terminal device 1500, and a change in temperature of the terminal device 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the terminal device 1500 and other devices. The terminal device 1500 can access a wireless network based on a communication standard, such as WiFi, 2G, or 3G, or a combination thereof. In one exemplary embodiment, the communication component 1516 receives a broadcast signal or broadcast information from an external broadcast management system via a broadcast channel. In one exemplary embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1504, executable by the processor 1520 in the terminal device 1500, for performing the above-described methods. For example, the non-transitory computer-readable storage medium may be a ROM, a RAM, a CD-ROM, a magnetic tape, a floppy disc, an optical data storage device, and the like.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for acquiring an image file, comprising:
transmitting, from a first device to a second device, an image capturing instruction requesting the second device to turn on a camera;
receiving, by the first device, image information transmitted from the second device according to the image capturing instruction, the image information being captured by the second device using the camera;
receiving, by the first device, an instruction input by a user; and
generating, by the first device, the image file based on the instruction and the image information.

2. The method according to claim 1, wherein the instruction includes a photo taking instruction, and wherein generating the image file comprises:
obtaining a latest image in the image information when the first device receives the instruction input by the user; and
generating the image file based on the latest image, the image file including a still image.

3. The method according to claim 1, wherein the instruction includes a video recording instruction, and wherein generating the image file comprises:
setting, by the first device, a time receiving the instruction as a start time and a time receiving a stop recording instruction as a stop time;
continuously capturing the image information from the start time till the stop time; and
generating the image file based on the image information, the image file including a plurality of video images.

4. The method according to claim 1, further comprising:
establishing, between the first device and the second device, a wireless connection;
transmitting, from the first device to the second device, a control request via the wireless connection;
receiving an indication sent from the second device indicating an acceptance of the control request; and
including an identifier of the second device in a device table.

5. The method according to claim 4, further comprising:
receiving, by the first device, a selection of the second device in the device table input by the user.

6. The method according to claim 1, further comprising:
transmitting, from the first device to the second device, the instruction, wherein the second device is configured to generate the image file based on the image information captured by the camera.

7. A method for providing image information, comprising:
receiving, by a second device, an image capturing instruction transmitted from a first device;
turning on a camera according to the image capturing instruction; and
transmitting the image information captured by the second device using the camera to the first device.

8. The method according to claim 7, further comprising:
when the image capturing instruction is received by the second device, maintaining a display status of a display screen of the second device.

9. The method according to claim 7, further comprising:
establishing, between the second device and the first device, a wireless connection;
receiving, by the second device, a control request transmitted from the first device via the wireless connection;
receiving, by the second device, an input by a user indicating an acceptance of the control request; and
sending an indication to the first device indicating the acceptance of the control request.

10. The method according to claim 7, further comprising:
receiving, by the second device, a user instruction transmitted from the first device; and
generating, by the second device, an image file based on the user instruction and the image information captured by the camera, the image file including a still image or a plurality of video images.

11. A first device for acquiring an image file, comprising:
a processor; and
a memory for storing instructions executable by the processor,
wherein the processer is configured to perform:
transmitting, from the first device to a second device, an image capturing instruction requesting the second device to turn on a camera;
receiving, by the first device, image information transmitted from the second device according to the image capturing instruction, the image information being captured by the second device using the camera;
receiving, by the first device, an instruction input by a user; and
generating, by the first device, the image file based on the instruction and the image information.

12. The first device according to claim 11, wherein the instruction includes a photo taking instruction, and wherein the processer is further configured to perform:
obtaining a latest image in the image information when the first device receives the instruction input by the user; and
generating the image file based on the latest image, the image file including a still image.

13. The first device according to claim 11, wherein the instruction includes a video recording instruction, and wherein the processer is further configured to perform:
setting, by the first device, a time receiving the instruction as a start time and a time receiving a stop recording instruction as a stop time;
continuously capturing the image information from the start time till the stop time; and
generating the image file based on the image information, the image file including a plurality of video images.

14. The first device according to claim 11, wherein the processor is further configured to perform:
establishing, between the first device and the second device, a wireless connection;
transmitting, from the first device to the second device, a control request via the wireless connection;
receiving an indication sent from the second device indicating an acceptance of the control request; and
including an identifier of the second device in a device table.

15. The first device according to claim 14, wherein the processor is further configured to perform:
receiving, by the first device, a selection of the second device in the device table input by the user.

16. The first device according to claim 11, wherein the processor is further configured to perform:
transmitting, from the first device to the second device, the instruction, wherein the second device is configured to generate the image file based on the image information captured by the camera.

17. A second device for providing image information, comprising:
a processor; and
a memory for storing instructions executable by the processor,
wherein the processer is configured to perform:
receiving, by the second device, an image capturing instruction transmitted from a first device;
turning on a camera according to the image capturing instruction; and
transmitting, to the first device, the image information captured by the second device using the camera.

18. The second device according to claim 17, wherein the processor is further configured to perform:
when the image capturing instruction is received by the second device, maintaining a display status of a display screen of the second device.

19. The second device according to claim 17, wherein the processor is further configured to perform:
establishing, between the second device and the first device, a wireless connection;
receiving, by the second device, a control request transmitted from the first device via the wireless connection;
receiving, by the second device, an input by a user indicating an acceptance of the control request; and
sending an indication to the first device indicating the acceptance of the control request.

20. The second device according to claim 17, wherein the processor is further configured to perform:
receiving, by the second device, a user instruction transmitted from the first device; and
generating, by the second device, an image file based on the user instruction and the image information captured by the camera, the image file including a still image or a plurality of video images.
